(19) United States
(12) Patent Application Publication
(10) Pub. No.: US 2007/0077901 A1
(43) Pub. Date: Apr. 5, 2007

(54) APPARATUS AND METHOD FOR CONTROLLING OUTPUT POWER OF MOBILE TERMINAL

(75) Inventor: Chang-Yong JUNG, Suwon (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/465,905

(22) Filed: Aug. 21, 2006

(30) Foreign Application Priority Data
Aug. 19, 2005 (KR) 10-2005-0076424

(51) Int. Cl. H01Q 11/12; H04B 1/04

(52) U.S. Cl. 455/127.1; 455/522; 455/69

(57) ABSTRACT

An apparatus for controlling output power of a mobile terminal which includes a power detector that detects a power level of a signal received from a base station, and a controller that determines a reference power value, based on the detected power level of the signal received from the base station, and controls a power of an RF signal transmitted by the mobile terminal, based on the determined reference power value.

This application claims the benefit of Korean Patent Application No. 10-2005-0076424, filed on Aug. 19, 2005, which is hereby incorporated by reference in its entirety.

### BACKGROUND OF THE INVENTION

1. Field of the Invention

The present invention relates to a mobile terminal and, more particularly, to an apparatus and method for controlling output power of a mobile terminal.

2. Description of the Related Art

Some mobile communication systems utilize a Time Division Multiple Access (TDMA) method to allocate limited frequency resources among a plurality of mobile communication subscribers vying for communication channels. A Global System for Mobile Communications (GSM) system is one such communication system. GSM is currently the de facto mobile communication standard in Europe.

A mobile communication system wirelessly connects a mobile terminal to a base station and determines a moving direction of the mobile terminal in real time. The base station determines a distance to the mobile terminal and uniformly maintains a communication sensitivity with the mobile terminal. In order to uniformly maintain the communication sensitivity, the base station uniformly maintains a power level of an RF signal outputted therefrom.

FIG. 1 is a schematic block diagram showing a conventional apparatus for controlling the output power of a mobile terminal which operates in a GSM system.

The apparatus 100 shown in FIG. 1 includes an RF signal generator 10 which generates an RF signal carrying a data signal to be transmitted through an antenna 40; a Power Amplifier Module (PAM) 20 which amplifies the RF signal generated by the RF signal generator 10; a coupler 30 which receives the amplified RF signal from the PAM 20, and sends it to a controller 50; and the controller 50. The controller 50 detects the power level of the amplified RF signal compares the detected power level to a reference power value, and sends a control signal, based on a difference value, to the PAM 20. The PAM 20 controls the amplification of the RF signal based on the control signal.

The coupler 30 also sends the amplified RF signal to the antenna 40.

An operation of the conventional apparatus 100 for controlling the output power of a mobile terminal is described below.

First, the RF signal generator 10 generates an RF signal , which is sent to the PAM 20.

The PAM 20 amplifies the RF signal by a predetermined amplification gain, and sends the amplified RF signal to the coupler 30. The amplification gain is determined based on the control signal provided by the controller 50.

The coupler 30 sends the amplified RF signal to the controller 50 and the antenna 40.

The amplified RF signal is then transmitted through the antenna 40 to a base station.

The controller 50 detects the power level of the amplified RF signal, compares the detected power level to a reference power value, and sends a control signal, based on a difference value, to the PAM 20. The control signal may take the form of an auto power control (APC) signal. The reference power value is stored in a memory of the mobile terminal, such as, for example, a memory associated with the controller 50.

After receiving the control signal from the controller 50, the PAM 20 amplifies the RF signal based on the control signal, in order to have the power of the amplified RF signal match the reference power value.

One of the disadvantages of the conventional apparatus 100 is that the reference power value is a static value which does not account for changes in a communication path between the mobile terminal and a base station. As the mobile terminal moves closer to a base station, or moves into a position in which the communication path is subject to less interference, signal reception between the base station and the mobile terminal improves. Thus, as the mobile terminal moves closer to a base station, it can transmit signals at a lower power level, while still achieving good signal reception at the base station. However, the conventional apparatus 100 described above does not take this into account.

For example, the reference power value of the conventional apparatus 100 may be set to 33 dBm. If the mobile terminal is close enough to a base station so that the base station can adequately receive signals which are transmitted from the mobile terminal at a level of 32 dBm, it is unnecessary for the mobile terminal to transmit at a level of 33 dBm. However, since the reference power value of the mobile terminal is set to 33 dBm, the mobile terminal will transmit at the level of 33 dBm. The transmission at the higher power level of 33 dBm not only increases the power consumption by the mobile terminal, but also causes increased interference to other devices in the area of the mobile terminal.

### BRIEF DESCRIPTION OF THE INVENTION

In view of the foregoing, the present invention, through one or more of its various aspects, embodiments, and/or specific features or sub-components, is thus intended to bring out one or more of the advantages as specifically noted below.

An object of the present invention is to provide an apparatus and method which reduces the power consumption of and interference caused by a mobile terminal.

To achieve at least this object, there is provided an apparatus for controlling output power of a mobile terminal which includes a power detector that detects a power level of a signal received from a base station, and a controller that determines a reference power value, based on the detected power level of the signal received from the base station, and controls a power of an RF signal transmitted by the mobile terminal, based on the determined reference power value.

The mobile terminal may operate in a Global System for Mobile Communication (GSM) system. The controller decreases the reference power value when the detected power level of the signal received from the base station is greater than a predetermined threshold, and increases the reference power value when the detected power level of the signal received from the base station is less than a predetermined threshold.

There is also provided an apparatus for controlling output power of a mobile terminal which includes a power amplifier module (PAM) that amplifies power of an RF signal, a power detector that detects a power level of a signal received from a base station and a controller that determines a reference power value, based on the detected power level of the signal received from the base station, and controls amplification of the RF signal, based on the determined reference power value.

The controller may detect a power level of an amplified RF signal, compare the detected power level of the amplified RF signal with the determined reference power value, and send a control signal to the PAM based on the comparison. The PAM may amplify the power of an RF signal based on the control signal. The controller may decrease the reference power value when the detected power level of the signal received from the base station is greater than a predetermined threshold, and/or may increase the reference power value when the detected power level of the signal received from the base station is less than a predetermined threshold.

There is also provided a method for controlling output power of a mobile terminal which includes detecting a power level of a signal received from a base station, determining a reference power value, based on the detected power level of the signal received from the base station, and controlling a power of an RF signal transmitted by the mobile terminal, based on the determined reference power value.

Determining a reference power value may include decreasing the reference power value when the detected power level of the signal received from the base station is greater than a predetermined threshold, and/or may include increasing the reference power value when the detected power level of the signal received from the base station is less than a predetermined threshold. Controlling the power of the RF signal may include controlling the power based on the decreased or increased reference power value.

There is also provided a method for controlling output power of a mobile terminal which includes detecting a power level of a signal received from a base station, decreasing a reference power value if the detected power level of the signal received from the base station is greater than a predetermined threshold, increasing the reference power value if the detected power level of the signal received from the base station is less than a predetermined threshold, and controlling a power of an RF signal transmitted by the mobile terminal, based on the reference power value.

There is also provided a computer-readable medium which stores a program for controlling output power of a mobile terminal. The program includes a power level detection code segment that detects a power level of a signal received from a base station, a reference power value determination code segment that determines a reference power value, based on the detected power level of the signal received from the base station, and a power control code segment that generates a control signal for controlling the power of an RF signal transmitted by the mobile terminal, based on the determined reference power value.

The reference power value determination code segment may decrease the reference power value when the detected power level of the signal received from the base station is greater than a predetermined threshold. The reference power value determination code segment may increase the reference power value when the detected power level of the signal received from the base station is less than a predetermined threshold. The program may also include an RF signal power level detection code segment that detects a power level of an RF signal transmitted by the mobile terminal. The power control code segment may compare the detected power level of the RF signal with the determined reference power value, and generate the control signal based on the comparison.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawings, and in which:

FIG. 1 is a schematic block diagram showing an apparatus for controlling output power of a mobile terminal according to a related art;

FIG. 2 is a schematic block diagram showing an embodiment of an apparatus for controlling output power of a mobile terminal according to one aspect of the present invention; and

FIG. 3 is a flow chart illustrating the processes of an embodiment of a method for controlling output power of a mobile terminal according to aspect of the present invention.

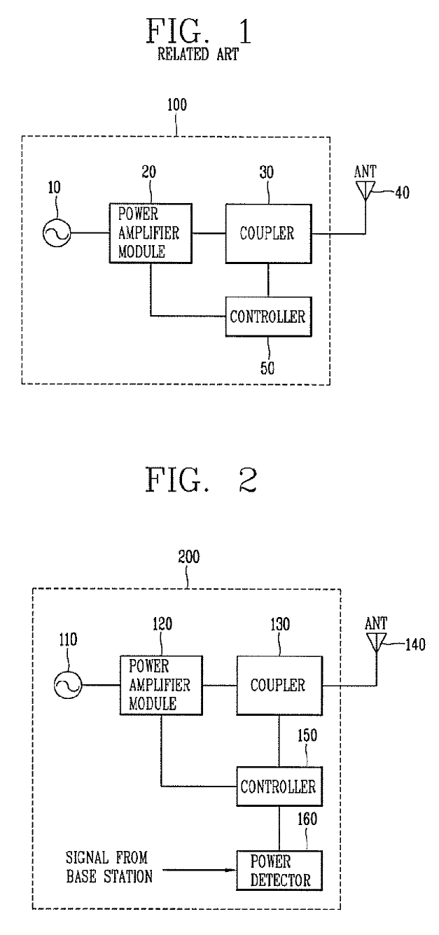

### DETAILED DESCRIPTION OF THE INVENTION

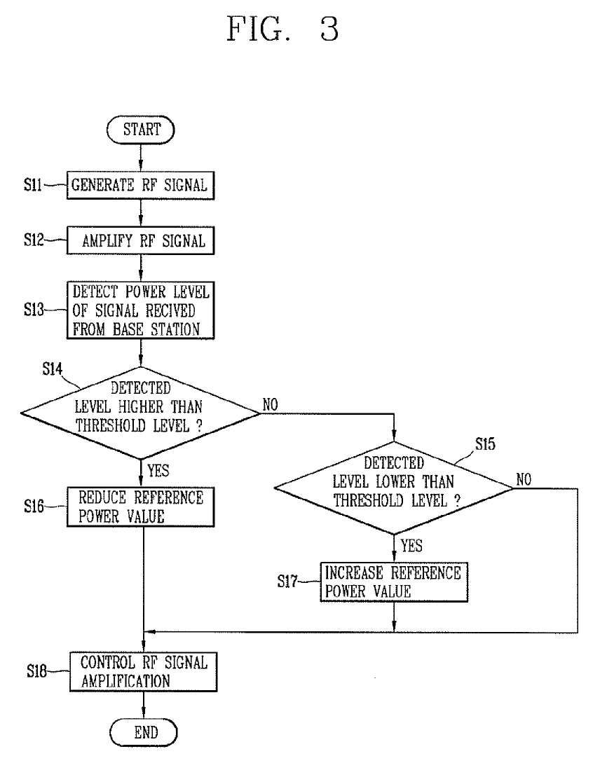

An apparatus and method for reducing the power consumption of a mobile terminal is described below with reference to FIGS. 2 and 3.

FIG. 2 is a schematic block diagram of an apparatus for controlling the power of an RF signal transmitted by a mobile terminal, according to an embodiment of the present invention. The mobile terminal may operate in a variety of mobile communication systems, such as but not limited to, for example, a GSM system. Of course it is understood that that alternative systems may be used without departing from the scope and/or spirit of the present invention.

The apparatus 200 shown in FIG. 2 includes an RF signal generator 110 that generates an RF signal carrying a data signal; a Power Amplifier Module (PAM) 120 that amplifies the RF signal; a coupler 130 which receives the amplified RF signal from the PAM 120, and sends a sample signal to a controller 150; a power detector 160 that detects the power level of a signal received from a base station; and the controller 150. The controller 150 detects the power level of the amplified RF signal, compares the detected power level to a reference power value, and sends a control signal, based on a difference value, to the PAM 120. The reference power value is stored in a memory of the mobile terminal, such as, for example, in a memory associated with the controller 150. The controller 150 varies the reference power value based on the detected power level of the signal received from the base station.

The PAM 120 controls the amplification of the RF signal based on the control signal. In this regard, if the power level of the RF signal is greater than the reference power value, the controller 150 outputs a first control signal which causes the PAM 120 to reduce the power of the RF signal. If the power level of the RF signal is less than the reference power value, the controller 150 outputs a second control signal which causes the PAM 120 to increase the power of the RF signal.

The coupler 130 sends the amplified RF signal to the controller 150 and a separately provided antenna 140.

An operation of the embodiment of the apparatus 200 shown in FIG. 2 is described below with reference to FIG. 3.

FIG. 3 is a flow chart illustrating a method for controlling the power of an RF signal transmitted by a mobile terminal.

First, the RF signal generator 110 generates an RF signal carrying a data signal (step S11).

Next, the PAM 120 amplifies the RF signal, based on a control signal generated from the controller 150, so that the power level of the RF signal matches the stored reference power level (step S12). The amplified RF signal is sent to the coupler 130, which then sends the amplified RF signal to the controller 150 and the antenna 140.

The power detector 160 detects the power level of a signal received from a base station, and outputs the detected power level to the controller 150 (step 313).

The controller 150 then varies the stored reference power level based on a detected power level of the signal received from the base station. For example, if the detected power level of the base station signal is strong, i.e., greater than a threshold level (e.g., greater than −90 dBm) (step S14—YES), it is unnecessary for the mobile terminal to transmit a signal at a high power level. Thus, the controller 150 lowers the reference power level of the mobile terminal (e.g., from 33 dBm to 32 dBm) (steps S16). However, if the detected power level of the base station signal is weak, i.e., less than the threshold level (e.g., less than −90 dBm) (step S14—NO, step S15—YES), the mobile terminal should transmit signals at a higher power level in order to obtain good signal reception at the base station. Thus, the controller 150 increases the reference power level of the mobile terminal (e.g., from 33 dBm to 34 dBm) (step S17). If the detected power level of the base station signal is average, i.e., equal to the threshold level (e.g., equal to −90 dBm) (step S14—NO, step S15—NO), the controller 150 does not change the reference power level.

The PAM 120 then controls the amplification of the RF signal based on the control signal provided by the controller 150 (step S18). The control signal is generated based on a comparison between the varied reference power level and the detected power of the RF signal. Accordingly, when the signal strength of the signal received from the base station is high, the output power of the mobile terminal is decreased. On the other hand, when the signal strength of the signal received from the base station is low, the output power of the mobile terminal is increased.

The apparatus and method described above offers several advantages. Among these advantages is that, by limiting the output power of a mobile terminal, power consumption is reduced (resulting in, for example, longer battery life), and interference to other electronic devices is reduced.

Further, by limiting the output power of a mobile terminal, the mobile terminal can more easily conform to Specific Absorption Rate (SAR) and Hearing Aids Compatibility (HAC) standards. Further, by increasing the output power of the mobile terminal when necessary, a Dropped Call Rate (DOCR) can be minimized.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

In accordance with various embodiments of the present disclosure, the methods described herein may be implemented by software programs executable by a processor. The present disclosure contemplates a computer-readable medium that includes instructions or receives and executes instructions responsive to a propagated signal. The term “computer-readable medium” shall include any medium that is capable of storing, encoding or carrying a set of instructions for execution by a processor to perform any one or more of the methods or operations disclosed herein.

In a particular non-limiting, exemplary embodiment , the computer-readable medium can include a solid-state memory such as, for example, a memory card or other package that houses one or more non-volatile read-only memories. Further, the computer-readable medium may be a random access memory or other volatile re-writable memory. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to an exemplary embodiment, it is understood that the words that have been used are words of description and illustrations rather than words of limitation s As the present invention may be embodied in several forms without departing from the spirit or essential characteristics thereof, it should also be understood that the above-described embodiment is not limited by any of the details of the foregoing description, unless otherwise specified. Rather, the above-described embodiment should be construed broadly within the spirit and scope of the present invention as defined in the appended claims. Therefore, changes may be made within the metes and bounds of the appended claims, as presently stated and as amended, without departing from the scope and spirit of the invention in its aspects.

What is claimed is:

1. An apparatus for controlling output power of a mobile terminal, comprising:
a power detector that detects a power level of a signal received from a base station; and
a controller that determines a reference power value , based on the detected power level of the signal received from the base station, and controls a power of an RF signal transmitted by the mobile terminal, based on the determined reference power value.

2. The apparatus according to claim 1, wherein the mobile terminal operates in a Global System for Mobile Communication (GSM) system.

3. The apparatus according to claim 1, wherein the controller decreases the reference power value when the detected power level of the signal received from the base station is greater than a predetermined threshold.

4. The apparatus according to claim 1, wherein the controller increases the reference power value when the detected power level of the signal received from the base station is less than a predetermined threshold.

5. An apparatus for controlling output power of a mobile terminal, comprising:
a power amplifier module (PAM) that amplifies power of an RF signal;
a power detector that detects a power level of a signal received from a base station; and
a controller that determines a reference power value, based on the detected power level of the signal received from the base station , and controls amplification of the RF signal, based on the determined reference power value.

6. The apparatus according to claim 5, wherein the controller detects a power level of an amplified RF signal, compares the detected power level of the amplified RF signal with the determined reference power value, and sends a control signal to the PAM based on the comparison.

7. The apparatus according to claim 6, wherein the PAM amplifies the power of an RF signal based on the control signal.

8. The apparatus according to claim 5, wherein the controller decreases the reference power value when the detected power level of the signal received from the base station is greater than a predetermined threshold.

9. The apparatus of claim 5, wherein the controller increases the reference power value when the detected power level of the signal received from the base station is less than a predetermined threshold.

10. A method for controlling output power of a mobile terminal, comprising:
detecting a power level of a signal received from a base station;
determining a reference power value, based on the detected power level of the signal received from the base station; and
controlling a power of an RF signal transmitted by the mobile terminal, based on the determined reference power value.

11. The method according to claim 10, wherein determining a reference power value comprises decreasing the reference power value when the detected power level of the signal received from the base station is greater than a predetermined threshold.

12. The method according to claim 11, wherein controlling the power of the RF signal comprises controlling the power based on the decreased reference power value.

13. The method according to claim 10, wherein determining a reference power value comprises increasing the reference power value when the detected power level of the signal received from the base station is less than a predetermined threshold.

14. The method according to claim 13, wherein controlling the power of the RF signal comprises controlling the power based on the increased reference power value.

15. A method for controlling output power of a mobile terminal, comprising:
detecting a power level of a signal received from a base station;
adjusting a reference power value by decreasing the reference power value if the detected power level of the signal received from the base station is greater than a predetermined threshold, and increasing the reference power value if the detected power level of the signal received from the base station is less than a predetermined threshold; and
controlling a power of an RF signal transmitted by the mobile terminal, based on the reference power value.

16. A computer-readable medium which stores a program for controlling output power of a mobile terminal, the program comprising:
a power level detection code segment that detects a power level of a signal received from a base station;
a reference power value determination code segment that determines a reference power value, based on the detected power level of the signal received from the base station; and
a power control code segment that generates a control signal for controlling the power of an RF signal transmitted by the mobile terminal, based on the determined reference power value.

17. The computer-readable medium according to claim 16, wherein the reference power value determination code segment decreases the reference power value when the detected power level of the signal received from the base station is greater than a predetermined threshold.

18. The computer-readable medium according to claim 16, wherein the reference power value determination code segment increases the reference power value when the detected power level of the signal received from the base station is less than a predetermined threshold.

19. The computer-readable medium according to claim 16, wherein the program further comprises an RF signal power level detection code segment that detects a power level of an RF signal transmitted by the mobile terminal.

20. The computer-readable medium according to claim 19, wherein the power control code segment compares the detected power level of the RF signal with the determined reference power value, and generates the control signal based on the comparison.
